(19) United States
(12) Patent Application Publication
(10) Pub. No.: US 2012/0186741 A1
(43) Pub. Date: Jul. 26, 2012

(54) APPARATUS FOR WAFER-TO-WAFER BONDING

(75) Inventor: RICKIE C. LAKE, Meridian, ID (US)

(73) Assignee: APTINA IMAGING CORPORATION, Georgetown Grand Cayman (KY)

(21) Appl. No.: 13/038,529

(22) Filed: Mar. 2, 2011

Related U.S. Application Data
(60) Provisional application No. 61/436,471, filed on Jan. 26, 2011.

(51) Int. Cl. B32B 37/10; C09J 5/00

(52) U.S. Cl. 156/306.3; 156/580

(57) ABSTRACT

An apparatus for bonding semiconductor wafers together including a moveable upper bond head and a resilient member positioned on a surface of the bond head for contacting a first wafer that is positioned at an elevation below the upper bond head. The resilient member is configured to apply a force onto a top side surface of the first wafer thereby compressing the first wafer against a second wafer that is positioned at an elevation below the first wafer. A method of wafer to wafer bonding includes the steps of positioning at least two wafers beneath the moveable upper bond head, positioning the resilient member in physical contact with one of the at least two wafers, and resiliently deforming the resilient member as it is moved into contact with the wafer to facilitate bonding of the wafers.

### CROSS REFERENCE TO RELATED APPLICATIONS

This application claims priority of U.S. Provisional Patent Application No. 61/436,471, filed on Jan. 26, 2011, which is incorporated herein by reference.

### FIELD OF THE INVENTION

This invention relates to the fabrication of semiconductor devices, Micro Electro Mechanical Systems (MEMS) devices, and more specifically to wafer bonding in fabrication of these devices.

### BACKGROUND OF THE INVENTION

A wafer is a thin slice of semiconductor material, such as a silicon crystal, that is used in the fabrication of integrated circuits and other microdevices. The wafer serves as the substrate for microelectronic devices built in and over the wafer and undergoes many microfabrication process steps such as doping or ion implantation, etching, deposition of various materials, and photolithographic patterning. Wafer to wafer bonding is widely used in fabrication of semiconductor devices, such as microelectromechanical systems (MEMS), micro-opto-electromechanical systems (MOEMS), and silicon on insulator (SOI).

In a typical wafer to wafer bonding process, two or more wafer substrates are placed on a flat surface of a bond fixture of a wafer bonding apparatus. Wafer bonding apparatuses are known in the art. A bond head of the wafer bonding apparatus is translated in a downward vertical direction to compress the wafer substrates together against the flat surface of the bond fixture. The mechanical stress at the bonding surfaces initiates, activates and stimulates the bonding process.

To achieve oxide bonding of the wafers, submicron flatness of the wafer surfaces, the bond head surface and the bond fixture surface may be necessary. The oxide bonding process is described in Effects of Plasma Activation on Hydrophilic Bonding of Si and SiO₂, Suni et al., Journal of the Electrochemical Society, Vol. 149, No. 6, 2002, PP. G348-351. Because it is difficult to guarantee submicron flatness for any component, there exists a need to improve upon the current wafer bonding process to improve the bonding of the wafer substrates, in the interest of increasing the fabrication yields of semiconductor devices.

### BRIEF DESCRIPTION OF THE DRAWINGS

The invention is best understood from the following detailed description when read in connection with the accompanying drawings. Included in the drawings are the following figures:

FIGS. 1-4 depict side elevation views of a simplified wafer bonding apparatus shown schematically, according to one embodiment of the invention. Those figures show an upper bond head progressively translating in a downward vertical direction toward a lower bond fixture.

FIG. 5 depicts another embodiment of a simplified wafer bonding apparatus shown schematically, which includes a resilient member positioned on the lower bond fixture, according to another embodiment of the invention.

FIG. 6 depicts another embodiment of a simplified wafer bonding apparatus shown schematically, which includes resilient members positioned on both the upper bond head and the lower bond fixture, according to yet another embodiment of the invention.

FIGS. 7A-7D depict side elevation views of different resilient members and their respective bond propagation diagrams.

### DETAILED DESCRIPTION OF THE INVENTION

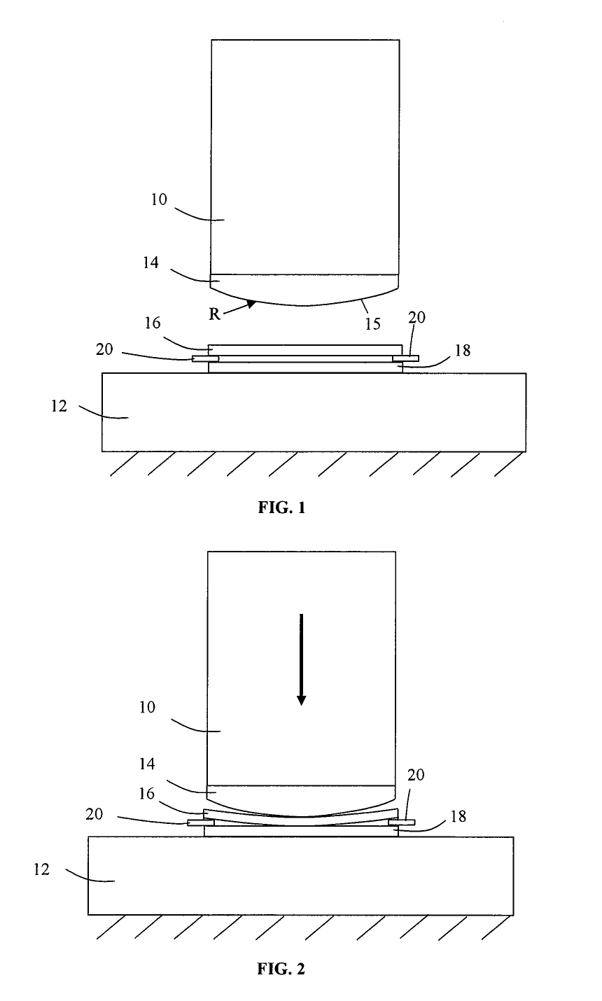

Referring now to FIGS. 1-4, a simplified wafer bonding apparatus, which is shown schematically, generally includes an upper bond head 10 that is configured to translate vertically with respect to a lower bond fixture 12 that is fixed in position. The lower bond fixture 12 may also be referred to in the art as a chuck. A resilient member 14 is adhered, or otherwise connected, to the machined face of the upper bond head 10. Two wafers 16 and 18 are positioned between the lower bond fixture 12 and the resilient member 14 of the upper bond head 10, as shown in FIG. 1. The wafer bonding apparatus is configured to compress the wafers 16 and 18 together to facilitate oxide bonding of the wafers.

The surfaces of the wafers 16 and 18, the upper bond head 10 and the lower bond fixture 12 may contain voids, imperfections, or other defects that affect their flatness. Such surface defects can upset the wafer bonding process, especially an oxide bonding process. By virtue of its resilient nature, the resilient member 14 is configured to compensate for any defects on surfaces of the wafers 16 and 18 as well as the machined lower surface of the upper bond head 10 and the machined upper surface of the lower bond fixture 12. More particularly, the resilient member 14 directly compensates for surface defects on the top wafer 16 and the machined face of the upper bond head 10, and indirectly compensates for surface defects on the bottom wafer 18 and the machined face of the lower bond fixture 12.

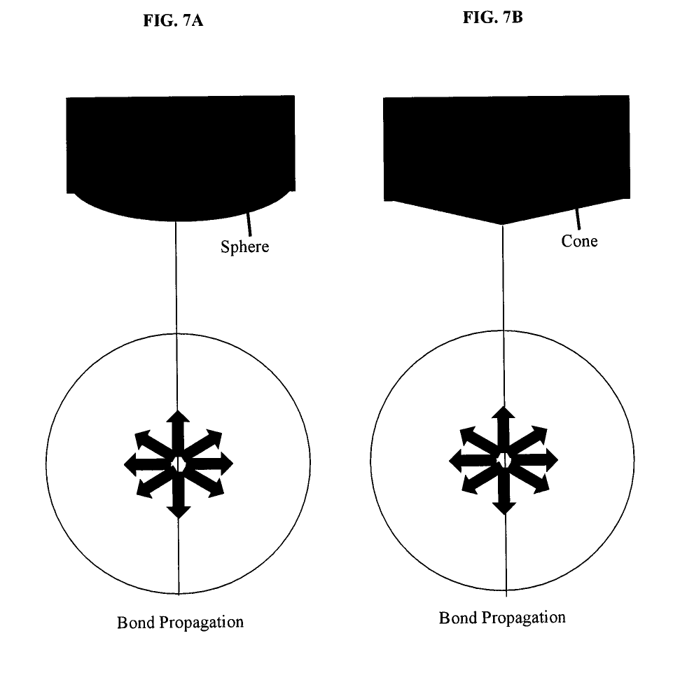

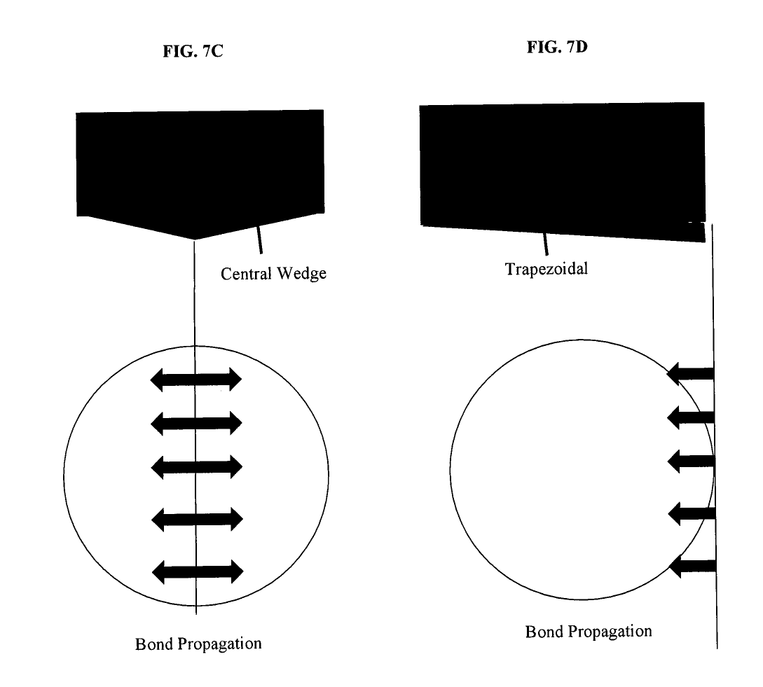

The wafer contacting surface 15 of the resilient member 14 is substantially hemispherical (see also FIG. 7A), having a pre-determined radius ‘R’. By virtue of its hemispherical shape, the thickness dimension of the resilient member 14 is greatest at the apex of the surface 15. As best shown in the side elevation view of FIGS. 7A-7D, the shape of the outer wafer contacting surface 15 of the resilient member 14 may vary. The shape of the outer wafer contacting surface 15 of the resilient member 14 may be planar or non-planar. For example, the wafer contacting surface of the resilient member may be hemispherical (FIG. 7A), oval-shaped, conical (FIG. 7B), wedge-shaped (FIGS. 7C and 7D), trapezoidal (FIG. 7D) or flat, for example.

The overall shape of the resilient member 14 can vary. As viewed from its wafer contacting surface, the resilient member 14 may have a circular shape, a square shape, or any other shape that compliments the shape of the wafers 16 and 18. The wafers 16 and 18 may be circular or square, for example.

The resilient member 14 is formed from a resilient material, such as silicone rubber, or any other material having a low Modulus of Elasticity. The Modulus of Elasticity of the resilient member 14 may be between 0 and 4 GPa, for example.

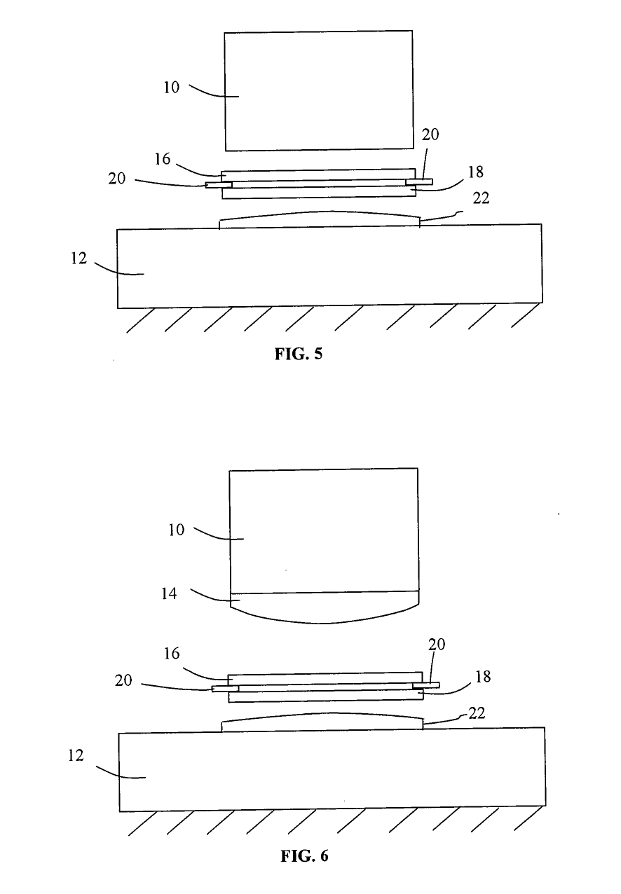

FIG. 5 depicts another embodiment of a simplified wafer bonding machine including a resilient member 22 positioned on the machined face of the bond fixture 12. The simplified wafer bonding apparatus of FIG. 5 is substantially similar to the simplified wafer bonding apparatus of FIGS. 1-4 with the exception that the resilient member 14 is omitted and a resilient member 22 is positioned on the machined face of the bond fixture 12.

The resilient member 22 directly compensates for surface defects on the bottom wafer 18 and the machined face of the lower bond fixture 12, and indirectly compensates for surface defects on the top wafer 16 and the machined face of the upper bond head 10. In contrast, the resilient member 14 of FIGS. 1-4 directly compensates for surface defects on the top wafer 16 and the machined face of the bond head 10, and indirectly compensates for surface defects on the bottom wafer 18 and the machined face of the bond fixture 12.

FIG. 6 depicts another embodiment of a simplified wafer bonding apparatus including a resilient member 14 that is positioned on the machined face of the upper bond head 10 and a resilient member 22 that is positioned on the machined face of the bond fixture 12. The resilient member 14 directly compensates for surface defects on the top wafer 16 and the machined face of the bond head 10, and the resilient member 22 directly compensates for surface defects on the bottom wafer 18 and the machined face of the lower bond fixture 12.

Referring now to the operation of the wafer bonding apparatus of FIGS. 1-4, the wafer 18 is positioned on the machined face of the bond fixture 12. A series of spacer flags 20 are positioned on top of the wafer 18. The other wafer 16 is positioned on top of the spacer flags 20. As shown in FIG. 1, the wafers 16 and 18 are physically separated by spacer flags 20 that are positioned between the wafers 16 and 18. The spacer flags 20 prevent any gas trapping between the wafers 16 and 18 before and during the bonding process.

As shown in FIG. 2, the upper bond head 10 is translated in a downward vertical direction. The hemispherical-shaped surface 15 initially contacts a small localized point in the center of the wafer 16. The apex of the wafer contacting surface 15 of the resilient member 14 gradually deflects the center of the top wafer 16 causing the bottom surface of the top wafer 16 to come into contact with the top surface of the bottom wafer 18.

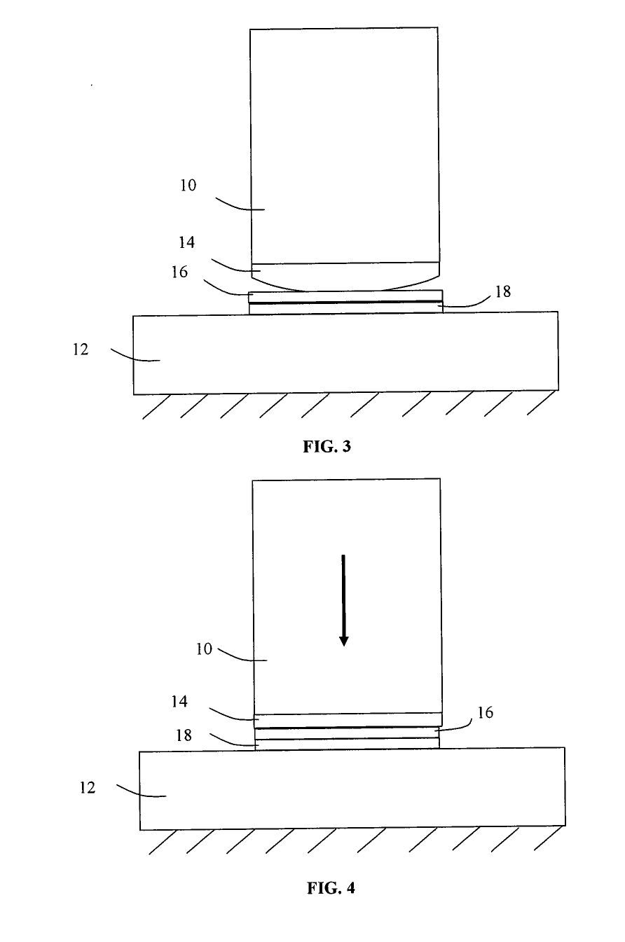

As shown in FIG. 3, the spacer flags 20 are then removed. Once the spacer flags 20 are removed, the entire bottom surface of the top wafer 16 comes into contact with the top surface of the bottom wafer 18 under the force of gravity. Alternatively, although not shown, the spacer flags 20 may be removed before the resilient member 14 makes contact with the top wafer 16.

As shown in FIG. 4, the upper bond head 10 is then translated further in the downward vertical direction. As the upper bond head 10 is translated further downward, the wafer contacting surface 15 of the resilient member 14 progressively applies a compressive force across the top surface of the wafer 16 in a radially outward direction toward the outer boundary of the wafer 16 until the resilient member 14 covers the entire top surface of the wafer 16. The pressure applied by the resilient member 14 onto the wafers 16 and 18 bonds the wafers 16 and 18 at their interface through the process of oxide bonding. The direction of propagation of the oxide bond is depicted in FIG. 7A. The process of oxide bonding can occur once the wafers 16 and 18 are positioned in contact, even without an applied compressive force.

Once the wafers 16 and 18 are sufficiently bonded together, the upper bond head 10 is translated in an upward vertical direction and the bonded wafers are removed from the wafer bonding apparatus. The wafer contacting surface 15 of the resilient member 14 eventually returns to its original shape.

As shown in FIGS. 7A-7D, the shape of the outer wafer contacting surface 15 influences the direction of bond propagation. The hemispherical and the conical wafer contacting surfaces shown in FIGS. 7A and 7B, respectively, cause the bond to propagate in a radially outward direction emanating from a small localized point at the center of the wafers. The wedge-shaped resilient member shown in FIG. 7C causes the bond to propagate in an outward direction emanating from a plane that traverses the central axis the wafers. The trapezoidal resilient member shown in FIG. 7D causes the bond to propagate from the right side of the wafers to the left side of the wafers.

The details of the operation of the simplified wafer bonding apparatus of FIGS. 1-4 equally applies to the simplified wafer bonding apparatuses of FIGS. 5 and 6.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. An apparatus for bonding semiconductor wafers together comprising:
a moveable upper bond head; and
a resilient member positioned on a surface of the bond head for contacting a first wafer that is positioned adjacent the upper bond head, wherein the resilient member is configured to apply a force onto a surface of the first wafer thereby compressing the first wafer against a second wafer that is positioned against the first wafer.

2. The apparatus of claim 1, wherein a wafer contacting surface of the resilient member is non-planar.

3. The apparatus of claim 1, wherein a wafer contacting surface of the resilient member is curved.

4. The apparatus of claim 1, wherein a wafer contacting surface of the resilient member is substantially hemispherical.

5. The apparatus of claim 1, wherein a thickness dimension of the resilient member is greatest at a central region of the resilient member.

6. The apparatus of claim 1, wherein a Modulus of Elasticity of the resilient member is between 0 and 4 GPa.

7. The apparatus of claim 1, wherein the resilient member covers the entire lower surface of the upper bond head.

8. The apparatus of claim 1 further comprising a bond fixture that is positioned at an elevation below the moveable upper bond head.

9. The apparatus of claim 8 further comprising a resilient member positioned on a surface of the bond fixture for contacting an underside surface of the second wafer.

10. An apparatus for bonding semiconductor wafers together comprising a resilient member that is at least partially composed of a resilient material and is configured to be positioned on either a bond head or a bond fixture, wherein the resilient member includes a wafer contacting surface that is resiliently deformable.

11. The apparatus of claim 10, wherein the wafer contacting surface of the resilient member is non-planar.

12. The apparatus of claim 10, wherein the wafer contacting surface of the resilient member is curved.

13. The apparatus of claim 10, wherein the wafer contacting surface of the resilient member is substantially hemispherical.

14. The apparatus of claim 10, wherein a thickness dimension of the resilient member is greatest at a central region of the resilient member.

15. The apparatus of claim 10, wherein the Modulus of Elasticity of the resilient member is between 0 and 4 GPa.

16. A method of wafer to wafer bonding comprising the steps of:
positioning at least two wafers beneath a moveable upper bond head of a wafer bonding apparatus;
positioning a resilient member, which is either attached to or defined on the moveable upper bond head, in physical contact with one of the at least two wafers; and
resiliently deforming the resilient member as the resilient member is positioned in physical contact with the wafer thereby facilitating bonding of the wafers.

17. The method of claim 16 further comprising the step of resiliently deforming another resilient member that is positioned in contact with the other of the at least two wafers.
